(19) United States
(12) Patent Application Publication
(10) Pub. No.: US 2002/0085067 A1
(43) Pub. Date: Jul. 4, 2002

(54) Ink jet printing module

(76) Inventors: Robert Palifka, Orford, NH (US); Paul A. Hoisington, Norwich, VT (US)

Correspondence Address: JOHN J. GAGEL, Fish & Richardson P.C., 225 Franklin Street, Boston, MA, 02110-2804, US

(21) Appl. No.: 09/749,893

(22) Filed: Dec. 29, 2000

(51) Int. Cl. B41J 2/045

(52) U.S. Cl. 347/71

(57) ABSTRACT

An ink jet printing module can be manufactured without the use of a liquid adhesive to bond components of the module. The module can include a thermoplastic bonding component.

### TECHNICAL FIELD

This invention relates to an ink jet printing module.

### BACKGROUND

An ink jet printing module ejects ink from an orifice in the direction of a substrate. The ink can be ejected as a series of droplets generated by a piezoelectric ink jet printing module. An example of a particular printing module can have 256 jets in four groups of 64 jets each. A piezoelectric ink jet printing module can includes a module body, a piezoelectric element, and electrical contacts that drive the piezoelectric element. Typically, the module body is a rectangular member into the surfaces of which are machined a series of ink channels that serve as pumping chambers for the ink. The piezoelectric element can be disposed over the surface of the body to cover the pumping chambers in a manner to pressurize the ink in the pumping chambers to eject the ink. The components of the module can be bonded together using a liquid adhesive, such as a liquid epoxy adhesive.

### SUMMARY

In general, an ink jet printing module manufactured without the use of a liquid adhesive to bond components of the module. The module can include a thermoplastic bonding component.

In one aspect, a method of manufacturing an ink jet printing module includes contacting a first component of an ink jet printing module having a surface with a thermoplastic bonding component; and heating the surface to bond the surface to the thermoplastic bonding component. The method can include applying pressure to the surface and the thermoplastic bonding component. The pressure can be applied during heating. The method can also include contacting a second component of the ink jet printing module having a surface with the thermoplastic bonding component; and heating the surface to bond the surface to the thermoplastic bonding component.

In another aspect, an ink jet printing module comprising a piezoelectric element having a surface, and a thermoplastic bonding component heat-bonded to the surface. The thermoplastic bonding component can include a first surface heat-bonded to the surface of the piezoelectric element and a second surface heat-bonded to a surface of an ink jet printing module component.

The thermoplastic bonding component can include a thermoplastic bonding material, such as an adhesive polyimide or a fluorinated ethylene propylene copolymer. The thermoplastic bonding component can have a thickness between 1 micron and 150 microns, between 10 micron and 125 microns, or between 20 microns and 50 microns. The thermoplastic bonding component can include an electrode pattern, for example, as a metallized film on one face of the component.

The first component of the ink jet printing module can be a piezoelectric element. The piezoelectric element can be lead zirconium titanate. The module can include an ink channel, the piezoelectric element being positioned to subject ink within the channel to jetting pressure, and electrical contacts arranged for activation of the piezoelectric element. The module can include a series of channels. The thermoplastic bonding component can be placed over the ink channel and can include a filter. The filter can include a repeating pattern of units having a plurality of openings having a land between the units of at least 50 microns. The units can be hexagonal.

The module can include an orifice plate. A protector strip can be adhered to the orifice plate. Either the orifice plate or the protector strip can include a thermoplastic bonding material.

The thermoplastic bonding component can include a thermoplastic bonding material, such as an adhesive polyimide or a fluorinated ethylene propylene copolymer. When the thermoplastic bonding component is an adhesive polyimide including flexible printed circuitry, the number of processing steps to form the ink jet printing module can be reduced, which can reduce the cost of an ink jet head assembly. The thermoplastic bonding component can bond to a variety of materials and can provide improved adhesion in comparison to a liquid adhesive. The thermoplastic bonding component is compatible with a wide variety of inks and fluids, making the ink jet printing module compatible with a variety of materials. The thermoplastic bonding component can bond to other materials when elevated to bonding temperatures, and without the use of separate adhesives, specifically liquid adhesives. Pressure can be applied to enhance bonding.

The details of one or more embodiments are set forth in the accompanying drawings and the description below. Other features and advantages of the invention will be apparent from the description and drawings, and from the claims.

### DESCRIPTION OF DRAWINGS

FIGS. 1A and 1B are schematic diagrams depicting an ink jet printing module.

FIG. 2 is a schematic diagram depicting a portion of an ink jet printing module.

FIG. 3 is a schematic diagram depicting a portion of an ink jet printing module.

FIG. 4 is a schematic diagram depicting a portion of an ink jet printing module.

FIG. 5 is a schematic diagram depicting a filter.

FIG. 6 is a schematic diagram depicting a filter.

### DETAILED DESCRIPTION

In general, an ink jet printing module includes a piezoelectric element positioned over jetting regions of a body. The jetting regions can be portions of pumping chambers within the body. A polymer, such as flex print, can seal the pumping chambers. Electrical contacts, such as electrodes, can be positioned on a surface of the piezoelectric element. The piezoelectric element spans each jetting region. When a voltage is applied to an electrical contact, the shape of the piezoelectric element changes in a jetting region, thereby subjecting the ink within the corresponding pumping chamber to jetting pressure. The ink is ejected from the pumping chamber and deposited on a substrate.

Components of the ink jet printing module can be bonded together using a thermoplastic bonding components, such as a film or a surface-treated component. The film or surface can be a thermoplastic, such as fluorinated ethylene propylene copolymer (FEP) or an adhesive polyimide film, such as UPILEX VT, available from Ube Industries. Adhesive polyimides are described, for example, in U.S. Pat. No. 5,728,473, which is incorporated herein by reference in its entirety. The thermoplastic bonding components can be a solid at room temperature and pressure and can be easy to handle. The thermoplastic bonding components can easily integrated in the assembly process and can form a bond in a short cycle time. Because a liquid adhesive is not used, the assembly process can be cleaner, due to the elimination of solvents and other volatile materials. The thermoplastic bonding component can be simply inserted between parts to be joined.

Bonding with the thermoplastic bonding component can eliminate use of a liquid adhesive and can simplify processing of the module. The bond between components can be formed by contacting component surfaces to form an assembly and applying heat and pressure to the assembly. Bonding can be accomplished in a few minutes. The thermoplastic material of the thermoplastic bonding component can flow little during the bonding process, so that adhesive layers of as much as 50 microns have been employed. The bond can form a seal over narrow lands, having widths as small as 10-100 microns. Because the thermoplastic bonding component does not include a liquid adhesive, the bonding process does not fill small passageways in the module. The thermoplastic bonding component can eliminate the need to apply a liquid adhesive precisely in a thin layer to bond components together.

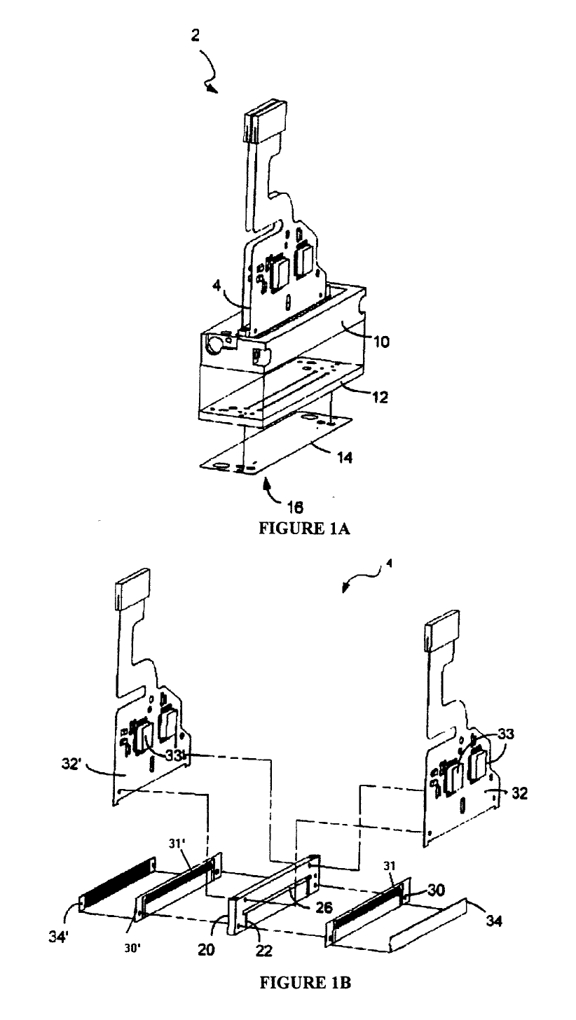

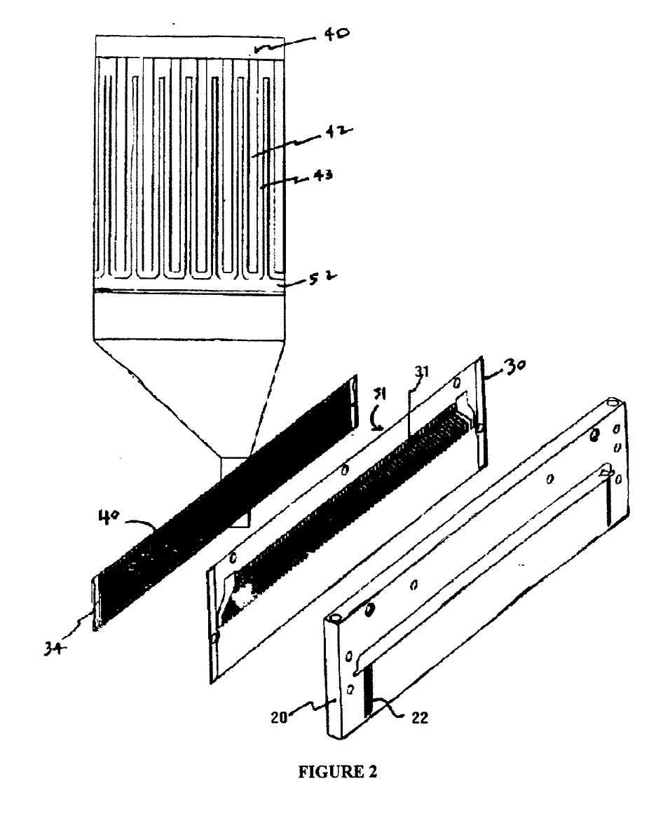

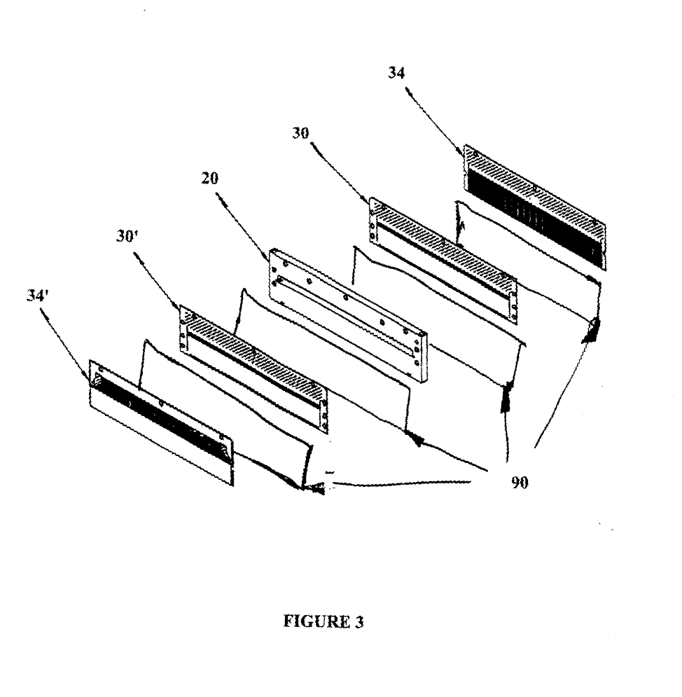

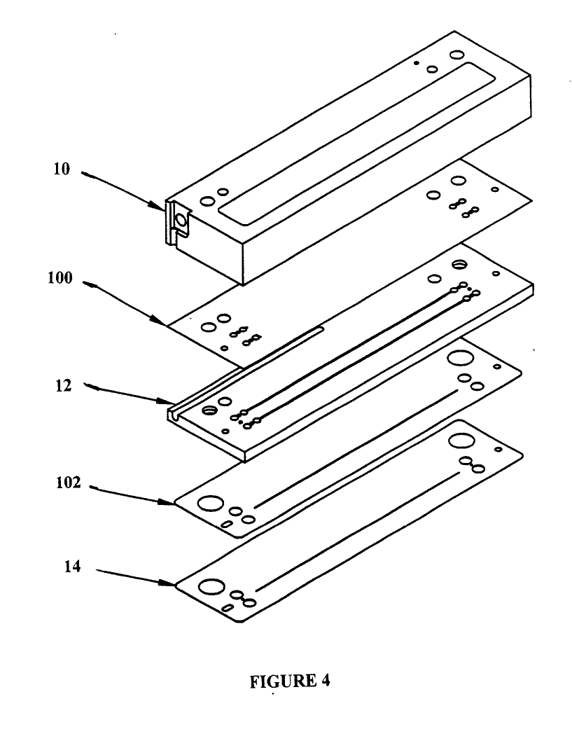

One example of a piezoelectric ink jet printing module is a shear mode module, such as the module described in U.S. Pat. No. 5,640,184, the entire contents of which is incorporated herein by reference. The electrical contacts in a shear mode module can be located on the side of the piezoelectric element adjacent to the ink channel. Referring to FIGS. 1A, 1B and 2, piezoelectric ink jet head 2 includes one or more modules 4 which are assembled into collar element 10 to which is attached manifold plate 12 and orifice plate 14. Ink is introduced into module 4 through collar 10. Module 4 is actuated to eject ink from orifices 16 on orifice plate 14. Ink jet printing module 4 includes body 20, which can be made from materials such as sintered carbon or a ceramic. A plurality of channels 22 are machined or otherwise manufactured into body 20 to form pumping chambers. Ink passes through ink fill passage 26, which is also machined into body 20, to fill the pumping chambers. Opposing surfaces of body 4 are covered with flexible polymer films 30 and 30′ that include a series of electrical contacts 31 and 31′ arranged to be positioned over the pumping chambers in body 20. Electrical contacts 31 and 31′ are connected to leads, which, in turn, can be connected to flex prints 32 and 32′ which include driver integrated circuits 33 and 33′. The films 30 and 30′ can be flex prints (e.g., UPILEX, such as UPILEX S, UPILEX VT, available from Ube Industries). Films 30 and 30′ are sealed to body 20. Film 30 and flex print 32 can be a single unit (not shown), or two units as shown. Surfaces between one or more of components 20, 30, 30′, 34, and 34′ can include the thermoplastic bonding material. The component can be formed from the bonding material, or the surface can be treated with the bonding material. Alternatively, referring to FIG. 3, thermoplastic bonding films 90 can be disposed between components 20, 30, 30′, 34, and 34′. The components can then be bonded at sufficient temperatures and pressures to bond the components together, for example, at temperatures greater than 150° C., 200° C. or 250° C. and pressures sufficient to form the bond. Referring to FIG. 4, thermoplastic bonding films 100 and 102 can be patterned, for example, using a laser, and disposed between components 10, 12, and 14.

Referring to FIG. 2, piezoelectric element 34 registers over film 30. Piezoelectric element 34 has electrodes 40 on the side of the piezoelectric element 34 that contacts film 30. Electrodes 40 register with electrical contacts 31 on side 51 of film 30, allowing the electrodes to be individually addressed by a driver integrated circuit. Electrodes 40 can be on a surface of piezoelectric element 34. Electrodes 40 can be formed by chemically etching away conductive metal that has been deposited onto the surface of the piezoelectric element. Suitable methods of forming electrodes are also described in U.S. Pat. No. 6,037,707, which is herein incorporated by reference in its entirety. The electrode can be formed of conductors such as copper, aluminum, titanium-tungsten, nickel-chrome, or gold. Each electrode 40 is placed and sized to correspond to a channel 22 in body 4 to form a pumping chamber. Each electrode 40 has elongated region 42, having a length and width slightly narrower than the dimensions of the pumping chamber such that gap 43 exists between the perimeter of electrodes 40 and the sides and end of the pumping chamber. These electrode regions 42, which are centered on the pumping chambers, are the drive electrodes that cover a jetting region of piezoelectric element 34. A second electrode 52 on piezoelectric element 34 generally corresponds to the area of body 20 outside channel 22, and, accordingly, outside the pumping chamber. Electrode 52 is the common (ground) electrode. Electrode 52 can be comb-shaped (as shown) or can be individually addressable electrode strips. The film electrodes and piezoelectric element electrodes overlap sufficiently for good electrical contact and easy alignment of the film and the piezoelectric element. The film electrodes extend beyond the piezoelectric element to allow for a soldered connection to the flex print 32 that contains the driving circuitry. Component 30 can be formed from the thermoplastic bonding material.

The piezoelectric element can be a single monolithic lead zirconium titanate (PZT) member. The piezoelectric element drives the ink from the pumping chambers by displacement induced by an applied voltage. The displacement is a function of, in part, the poling of the material. The piezoelectric element is poled by the application of an electric field. A poling process is described, for example, in U.S. Pat. No. 5,605,659, which is herein incorporated by reference in its entirety. The degree of poling can depend on the strength and duration of the applied electric field. When the poling voltage is removed, the piezoelectric domains are aligned.

Subsequent applications of an electric field, for example, during jetting, can cause a shape change proportional to the applied electric field strength. Variations in the applied electric field in a direction opposing the polarization can cumulatively and continuously degrade the polarization. In addition, heating the piezoelectric material to the Curie point can cause depoling, or loss of polarization. The bonding temperature can be below the Curie point of the piezoelectric element if the piezoelectric element is poled before bonding.

The orifice plate can be manufactured from self-adhering materials such as a thermoplastic bonding component, for example, a polyimide. The thermoplastic bonding component is stable in the presence of inks and cleaning materials. The orifice plate made from a themoplastic bonding component can be manufactured using laser ablation techniques, for example, with an excimer laser, or by other manufacturing methods. An orifice plate protector strip can be placed over the nozzles to prevent contamination during manufacture and before use. The protector strip can be a thermoplastic bonding material, such as UPILEX VT. The strip can be lightly adhered to the nozzle exit face by varying the temperatures and pressure of the bond to achieve the degree of adhesion required to peel the strip when the printing module is to be used. The strip can be applied to a wide variety of nozzle materials, such as metals, plastics, and ceramics. If the orifice plate is made from a thermoplastic bonding component, such as an adhesive polyimide, for example, UPILEX VT, a strip of another material, such as another polyimide, for example, UPILEX S, can be lightly adhered to the nozzle.

Patterning the electrodes on a PZT element can be an expensive process. Flex prints and circuit boards can be patterned less expensively. By bonding an electrode pattern on a polymer film, such as a flex print, to a piezoelectric element, costly electrode patterning on the piezoelectric surface can be avoided. Conductive particles can be added at the interface between the piezoelectric surface and the electrodes to enhance electrical contact. A process of this type is described, for example, in U.S. Pat. No. 6,037,707. The flex print can be a thermoplastic bonding material, such as FEP or an adhesive polyimide, which can form a seal with adjacent components when bonded. The bonding can improve electrical contact with electrodes on the polymer film. When the thermoplastic bonding component is a flexible printed circuit made from an adhesive polyimide, such as a self-adhering polyimide, a surface can be metallized to form electrodes on a surface of the flexible printed circuit. When thermoplastic bonding components contact both sides of the piezoelectric element, the patterning on the flexible printed circuit can perform as both the electrodes and ground planes of the module, eliminating the need to pattern electrodes on the surface of the piezoelectric element directly, which can reduce cost.

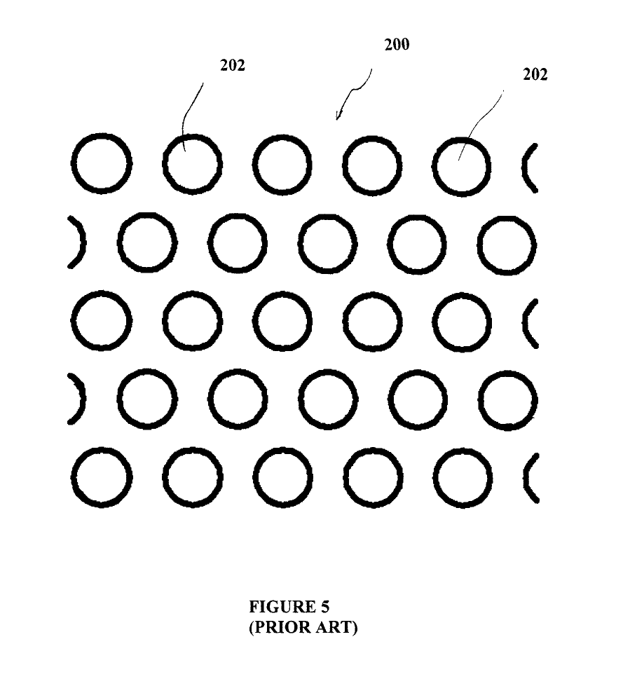

Ink jet printing modules can include a filter that can prevent oversized solid material in the ink from entering a channel and clogging an exit orifice of the module. A film having a pattern of holes can be disposed over the channels to form the filter. Referring to FIG. 5, pattern 200 of previous filters is a continuous array of holes 202. The holes have an average diameter of 25-30 microns, and a center-to-center spacing of 45 microns. The array of holes is continuous and has a width of 2000 microns.

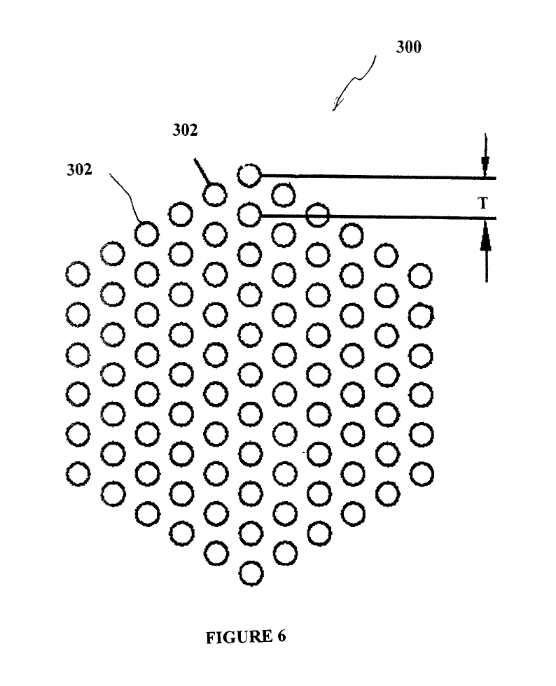

A filter manufactured from a thermoplastic bonding material, such as an adhesive polyimide, bonds to other parts in the module, for example, under pressure and temperature conditions. By eliminating liquid adhesive, adhesive spill over is minimized or eliminated, increasing the surface area available for filtering. The elimination of adhesive spill over can improve manufacturing reliability and improve filter performance. The manufacturing process can be simplified and manufacturing costs can be reduced. The lack of adhesive spill over can allow a larger area over the channel to be covered by the filter. Referring to FIG. 6, a filter for each channel can have an array of filters 300, which cover the channel in the module. The filter covers a higher proportion of the channel cross section than the filter depicted in FIG. 5. Filter 300 includes a plurality of openings 302 having diameters of 25 to 30 microns, and spaced 48 microns apart, distance T. The openings 302 can form a hexagonal pattern having, for example, six openings along each side of the hexagon. The hexagons of the filter can be arranged in an edge-to-edge manner with a land between hexagons of at least 50 microns. Each hexagon is placed over a channel to filter the ink. The hexagonal pattern can reduce or eliminate cross-talk between jets. The hexagonal pattern can also simplify manufacture and relax the manufacturing tolerances of the filter.

A number of embodiments have been described. Other embodiments are within the scope of the following claims.

What is claimed is:

1. A method of manufacturing an inkjet printing module comprising:
contacting a first component of an ink jet printing module having a surface with a thermoplastic bonding component; and
heating the surface to bond the surface to the thermoplastic bonding component.

2. The method of claim 1, further comprising applying pressure to the surface and the thermoplastic bonding component.

3. The method of claim 2, wherein pressure is applied during heating.

4. The method of claim 1, wherein the surface and the thermoplastic bonding component are substantially free of liquid adhesive.

5. The method of claim 1, further comprising contacting a second component of the ink jet printing module having a surface with the thermoplastic bonding component; and heating the surface to bond the surface to the thermoplastic bonding component.

6. The method of claim 1, wherein the first component of the ink jet printing module is a piezoelectric element.

7. The method of claim 6, wherein the thermoplastic bonding component includes an electrode pattern.

8. The method of claim 6, wherein the piezoelectric element is lead zirconium titanate.

9. The method of claim 1, wherein the thermoplastic bonding component has a thickness between 1 micron and 150 microns.

10. The method of claim 1, wherein the thermoplastic bonding component has a thickness between 10 micron and 125 microns.

11. The method of claim 1, wherein the thermoplastic bonding component has a thickness between 20 microns and 50 microns.

12. The method of claim 1, wherein the thermoplastic bonding component includes an adhesive polyimide.

13. The method of claim 1, wherein the ink jet printing module includes an ink channel, the piezoelectric element being positioned to subject ink within the channel to jetting pressure, and electrical contacts arranged for activation of the piezoelectric element.

14. The method of claim 13, wherein the ink jet printing module includes a series of channels.

15. The method of claim 13, wherein the thermoplastic bonding component is placed over the ink channel and includes a filter.

16. The method of claim 15, wherein the filter includes a repeating pattern of units having a plurality of openings.

17. The method of claim 16, wherein a land between the units is at least 50 microns.

18. The method of claim 1, wherein the module includes an orifice plate and the method further comprises adhering a protector strip over the orifice plate.

19. The method of claim 18, wherein the orifice plate includes a thermoplastic bonding material adjacent to the protector strip.

20. The method of claim 18, wherein the protector strip includes a thermoplastic bonding material adjacent to the orifice strip.

21. A method of manufacturing an ink jet printing module comprising:
contacting a first component of an ink jet printing module having a surface with a thermoplastic bonding component;
contacting a second component of the ink jet printing module having a surface with the thermoplastic bonding component; and
heating the surface to bond the surfaces to the thermoplastic bonding component.

22. The method of claim 21, further comprising applying pressure to the surface and the thermoplastic bonding component.

23. The method of claim 21, wherein pressure is applied during heating.

24. The method of claim 21, wherein the surface and the thermoplastic bonding component are substantially free of liquid adhesive.

25. The method of claim 21, wherein the first component of the ink jet printing module is a piezoelectric element.

26. The method of claim 21, wherein the ink jet printing module includes an ink channel, the piezoelectric element being positioned to subject ink within the channel to jetting pressure, and electrical contacts arranged for activation of the piezoelectric element.

27. The method of claim 26, wherein the thermoplastic bonding component is placed over the ink channel and includes a filter including a repeating pattern of units having a plurality of openings and a land between the units is at least 50 microns.

28. The method of claim 21, wherein the module includes an orifice plate and the method further comprises adhering a protector strip over the orifice plate.

29. An ink jet printing module comprising a piezoelectric element having a surface, and a thermoplastic bonding component heat-bonded to the surface.

30. The ink jet printing module of claim 29, wherein the thermoplastic bonding component includes a first surface heat-bonded to the surface of the piezoelectric element and a second surface heat-bonded to a surface of an ink jet printing module component.

31. The ink jet printing module of claim 29, wherein the thermoplastic bonding component includes an electrode pattern.

32. The ink jet printing module of claim 29, wherein the piezoelectric element is lead zirconium titanate.

33. The ink jet printing module of claim 29, wherein the thermoplastic bonding component has a thickness between 1 micron and 150 microns.

34. The ink jet printing module of claim 29, wherein the thermoplastic bonding component has a thickness between 10 micron and 125 microns.

35. The ink jet printing module of claim 29, wherein the thermoplastic bonding component has a thickness between 20 microns and 50 microns.

36. The ink jet printing module of claim 29, wherein the thermoplastic bonding component includes an adhesive polyimide.

37. The ink jet printing module of claim 29, further comprising an ink channel, the piezoelectric element being positioned to subject ink within the channel to jetting pressure, and electrical contacts arranged for activation of the piezoelectric element.

38. The ink jet printing module of claim 37, further comprising a series of channels.

39. The ink jet printing module of claim 38, wherein each of said channels is covered by a single piezoelectric element.

40. The ink jet printing module of claim 37, wherein the thermoplastic bonding component covers the ink channel and includes a filter.

41. The ink jet printing module of claim 40, wherein the filter including a repeating pattern of units having a plurality of openings and a land between the units is at least 50 microns.

42. The ink jet printing module of claim 41, wherein the width is 300 to 495 microns.

43. The ink jet printing module of claim 29, further comprising an orifice plate and a protector strip adhered to the orifice plate, wherein either the orifice plate or the protector strip includes a thermoplastic bonding material.
